(19) United States
(12) Patent Application Publication
(10) Pub. No.: US 2022/0309408 A1
(43) Pub. Date: Sep. 29, 2022

(54) ASSET TRACKING SYSTEM

(71) Applicant: ViewTag, LLC, West Chester, PA (US)

(72) Inventors: Anthony J. DIVALERIO, III, West Chester, PA (US); Richard O. WARTHER, West Chester, PA (US)

(21) Appl. No.: 17/701,841

(22) Filed: Mar. 23, 2022

Related U.S. Application Data
(60) Provisional application No. 63/165,401, filed on Mar. 24, 2021.

(51) Int. Cl. G06Q 10/02; G06Q 50/14

(52) U.S. Cl. CPC G06Q 10/025; G06Q 50/14

(57) ABSTRACT

The present invention is directed to an asset tracking system having a central server configured to receive flight information and a baggage identification number for baggage. The system requests that a driving service schedule a first driving trip and sends dropoff locations to the driving service. The system receives confirmation that the baggage was received at the departure airport, that the baggage was loaded onto an airplane, that the airplane arrived at a destination airport, and that the baggage was unloaded from the plane and transported to a baggage claim area at the destination airport. The system requests that the driving service schedule a second driving trip and receives confirmation that the user and the baggage have begun the second driving trip. The system notifies a hotel upon that the user and the baggage have begun the second driving trip and receives hotel room information from the hotel.

### CROSS-REFERENCE TO RELATED APPLICATIONS

The present application claims the benefit of U.S. Provisional Patent Application No. 63/165,401, filed on Mar. 24, 2021 and titled “Asset Tracking System,” the entire contents of which are incorporated herein by reference in their entirety.

### BACKGROUND OF THE INVENTION

Embodiments of the present invention are generally directed to asset tracking systems for automating the transport of passengers, luggage, and other assets from their homes, through airports and other transit depots, and to their destinations.

Asset tracking systems in airports are generally known. Some prior art systems allow for a user to utilize an application to track the status of their baggage as it passes through an airport's luggage handling system. However, these systems are limited to use at airports and do not extend to a user's transportation to and from an airport, the possibility of the baggage being transported to an ultimate destination like a hotel, or a user's use of a different mode of transportation such as a train or ferry.

Accordingly, there is a need for an expanded asset tracking system capable of tracking a user's assets from his or her home through the entire length of their journey.

### BRIEF SUMMARY OF THE INVENTION

In one aspect, an embodiment of the present invention is directed to an asset tracking system having a central server configured to receive flight information from a user or from an airline, the flight information including traveler information, airport information, and baggage information; receive, from the airline, a baggage identification number associated with baggage. The asset tracking system allows a user to send a request to a driving service to schedule a first driving trip and send a first dropoff location and a second dropoff location to the driving service. The first and second dropoff location both located at a departure airport and determined at least in part based on the flight information. The system receives information confirming that the baggage was received at the departure airport; receives information confirming that the baggage was transported to and loaded onto an airplane; receives information confirming that the airplane arrived at a destination airport; and receives information confirming that the baggage was unloaded from the airplane and transported to a baggage claim area at the destination airport. The system sends a request to the driving service to schedule a second driving trip upon receipt of the information confirming that the baggage was unloaded from the airplane and transported to a baggage claim area at the destination airport; receive information confirming that the user and the baggage have begun the second driving trip. Finally, the system sends a notification to a hotel upon receipt of the information confirming that the user and the baggage have begun the second driving trip; and receive hotel room information from the hotel.

In another aspect, an embodiment of the present invention is directed to method for using an asset tracking system, the method including checking in to a flight, including entering baggage information indicating that baggage will be transported on the flight. The method also includes receiving a digital boarding pass associated with the flight, scheduling a date and time to be retrieved by a driving service, and traveling to a departure airport via a first car provided by the driving service. The method further includes receiving information confirming that the baggage was scanned at a dropoff location at the departure airport, traveling on the flight to a destination airport, and receiving information confirming that the baggage was unloaded from the flight and will be available at a baggage claim area. The method also includes retrieving the baggage from the baggage claim area, receiving information confirming that a second car has been ordered from the driving service, and traveling to a final destination via the second car.

In another aspect, an embodiment of the present invention is directed to an asset tracking system having a central server configured to prompt a user to enter flight information, the flight information comprising flyer information, airport information, and baggage information. The central server is also configured to create a baggage identification number associated with baggage of the user and provide a boarding pass to the user. The central server is further configured to receive information confirming that the user arrived at a departure airport, receive information confirming that the baggage was received at the departure airport, and send information to the user confirming that the baggage was received at the departure airport. The central server is further configured to receive information confirming that the baggage was transported to and loaded onto an airplane and send information to the user confirming that the baggage was transported to and loaded onto the airplane. The central server is also configured to receive information confirming that the airplane arrived at a destination airport, receive information confirming that the baggage was unloaded from the airplane and transported to a baggage claim area at the destination airport, and send information to the user confirming that the baggage was unloaded from the airplane and transported to the baggage claim area at the destination airport.

In another aspect, an embodiment of the present invention is directed to an asset tracking system having a baggage dropoff scanner for accepting baggage. The asset tracking system also has a first conveyor system for transporting the baggage through a first airport to an airplane, wherein the conveyor system has at least one scanner for tracking the location of the baggage. The asset tracking system further has a loading scanner for tracking the baggage on to a plane and an unloading scanner for identifying the baggage as it is unloaded from the airplane. The asset tracking system also has a second conveyor system for transporting the baggage from the airplane through a second airport to a baggage claim area, wherein the conveyor system has at least one scanner for tracking the location of the baggage. Finally, the asset tracking system has a baggage claim scanner for identifying the baggage as it is delivered to the baggage claim area.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram of an asset tracking system in accordance with a first exemplary embodiment of the present invention;

FIG. 2 is an exemplary schematic layout of an asset tracking network in which the asset tracking system of FIG. 1 can be utilized;

FIG. 3 is a schematic view of a departure airport of the asset tracking network of FIG. 2;

FIG. 4 is a schematic view of a destination airport of the asset tracking network of FIG. 2;

FIG. 5 is an exemplary sequence diagram tracking the process used in an exemplary embodiment of the asset tracking system of FIG. 1;

FIG. 6 is a flow chart showing a first exemplary method of using the asset tracking system of FIG. 1;

FIG. 7 is a flow chart showing a second exemplary method of using the asset tracking system of FIG. 1; and

FIG. 8 is a flow chart showing a third exemplary method of using the asset tracking system of FIG. 1.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and instruments and related parts thereof. The terminology includes the above-listed words, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

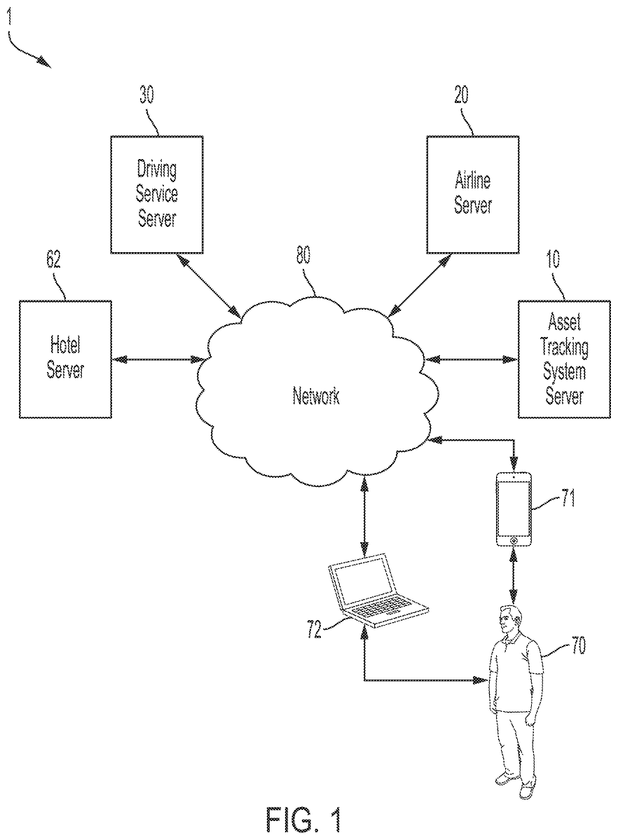

Referring to FIG. 1, one embodiment of the present invention is directed to a asset tracking system 1 having a asset tracking system server 10, an airline server 20, a driving service server 30, a hotel server 62, and a user 70. The asset tracking system server 10, airline server 20, driving service server 30, hotel server 62, and user 70 all preferably interact with one another through a network 80. The airline server 20 may be a server controlled by an airline itself or it may be a departure control system controlled by a third party. The driving service server 30 is preferably associated with a taxi or car-for-hire service operator, but is not so limited and may be a server 30 associated with any operator or service that can be hired to transport the user 70 from one place to another. The network 80 is preferably the Internet, but the invention is not so limited and the network 80 may be any network of electronic devices sufficient to facilitate electronic communication, such as an intranet. The user 70 preferably interacts with the network 80 via a mobile device 71 or a personal computer 72. The mobile device 71 is preferably a smartphone, smart watch, a tablet, or the like, but the invention is not so limited.

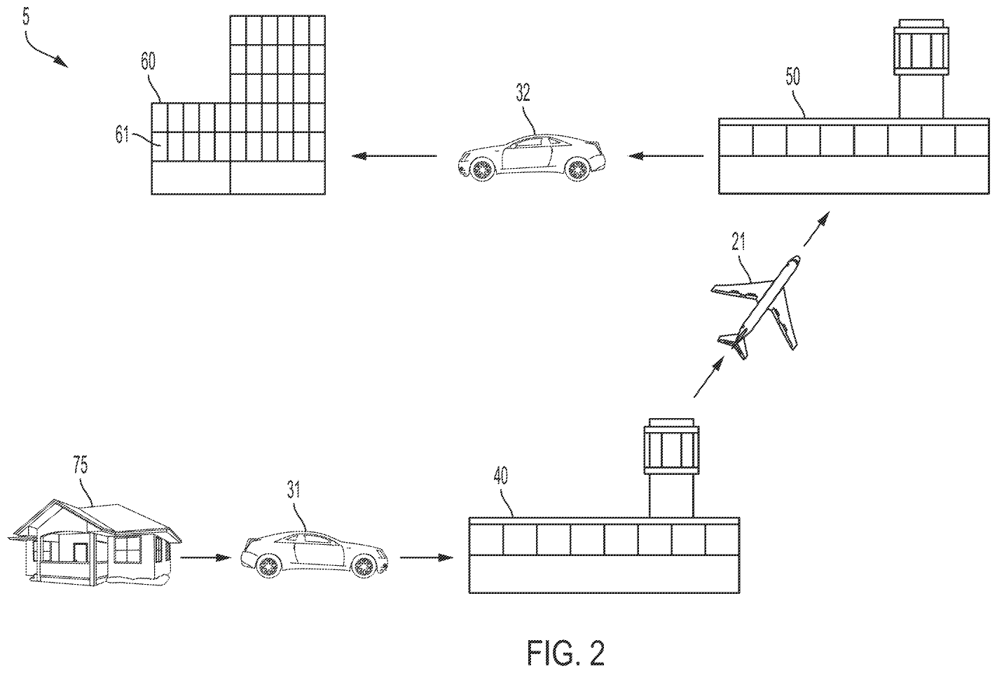

Referring now to FIG. 2, an exemplary schematic layout of a asset tracking network 5 is shown. The asset tracking network 5 preferably includes a user's home 75, a first vehicle 31, a departure transit hub 40, a multi-passenger vehicle 21, a destination transit hub 50, a second vehicle 32, and a hotel 60. The transit hubs 40 and 50 are preferably airports, but the invention is not so limited, and the transit hubs 40 and 50 may be any type of transit hub, such as ferry terminals, train stations, bus stations, monorail stations, helipads, designated dropoff points, and the like. Similarly, the multi-passenger vehicle 21 is preferably an airplane, but the invention is not so limited and the multi-passenger vehicle 21 may be any type of mass transit vehicle, such as a ferry, a train, a bus, a monorail, a helicopter, or the like. For the purposes of the exemplary embodiments in this disclosure, the transit hubs 40 and 50 will be referred to as airports 40 and 50 and the multi-passenger vehicle 21 will be referred to as an airplane 21. The hotel 60 preferably includes hotel rooms 61.

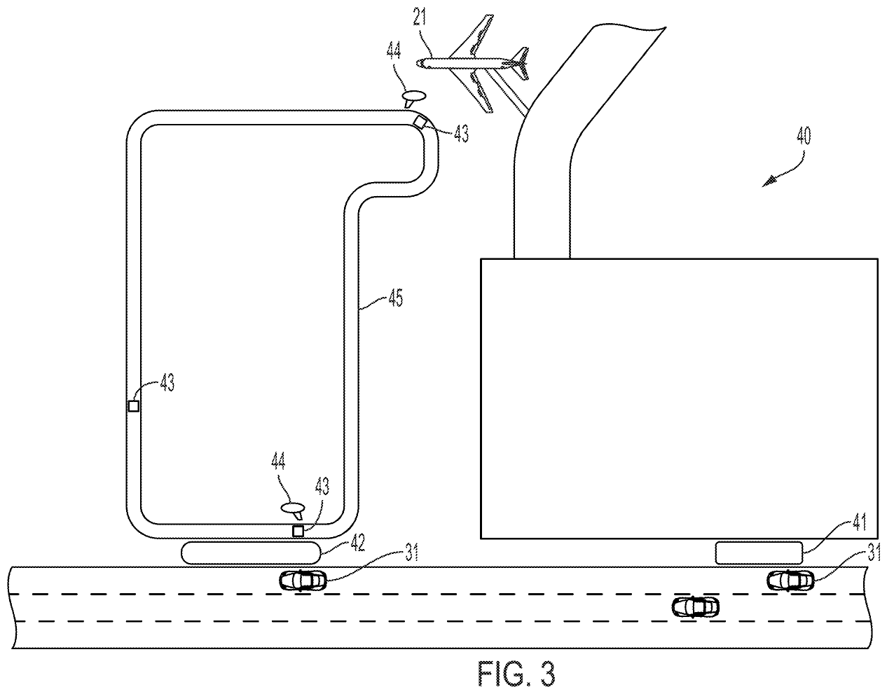

Referring now to FIG. 3, an exemplary schematic layout of a departure airport 40 is shown. The departure airport preferably includes a first dropoff location 41 at which the user 70 arrives at the departure airport 40 to check himself or herself in for travel. The departure airport 40 also preferably includes a scanner 44 for accepting baggage 43 at a second dropoff location 42. The departure airport 40 also preferably includes a first conveyor system 45 for transporting the baggage 43 through the departure airport 40 to an airplane 21. Preferably, the first conveyor system 45 has at least one scanner 44 for tracking the location of the checked luggage 43 as it passes through the conveyor system 45. The departure airport 40 also preferably includes another scanner 44 for tracking the baggage 43 on to the airplane 21.

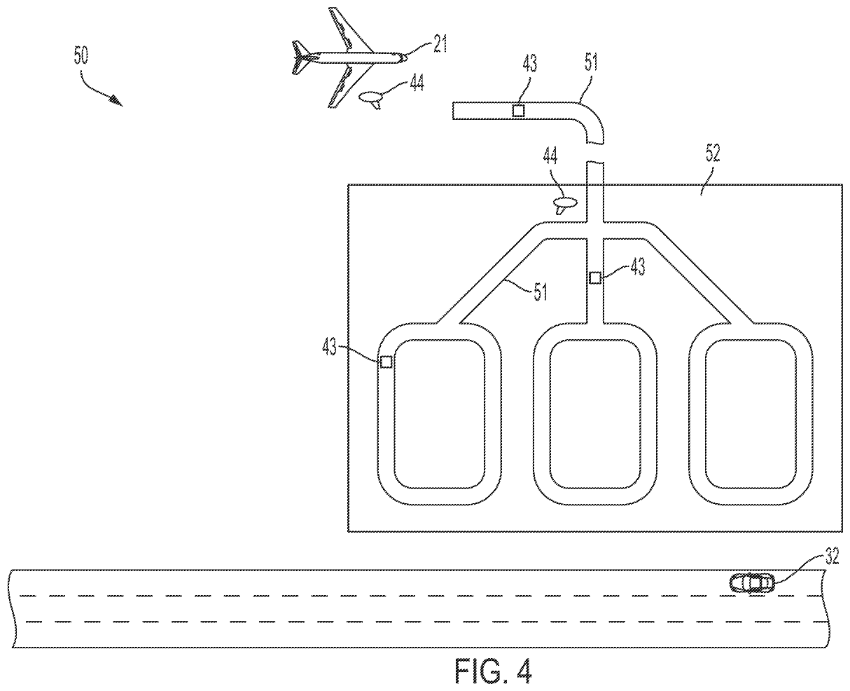

Referring now to FIG. 4, an exemplary schematic layout of a destination airport 50 is shown. The destination airport 50 also preferably includes a scanner 44 for identifying the baggage 43 as it is unloaded from the airplane 21. The destination airport 40 also preferably includes a second conveyor system 51 for transporting the baggage 43 from the airplane 21 through the destination airport 50 to a baggage claim area 52, the second conveyor system 51 having at least one scanner 44 for tracking the location of the baggage 43. The destination airport 50 further preferably includes a scanner 44 for identifying the baggage 43 as it is delivered to the baggage claim area 52.

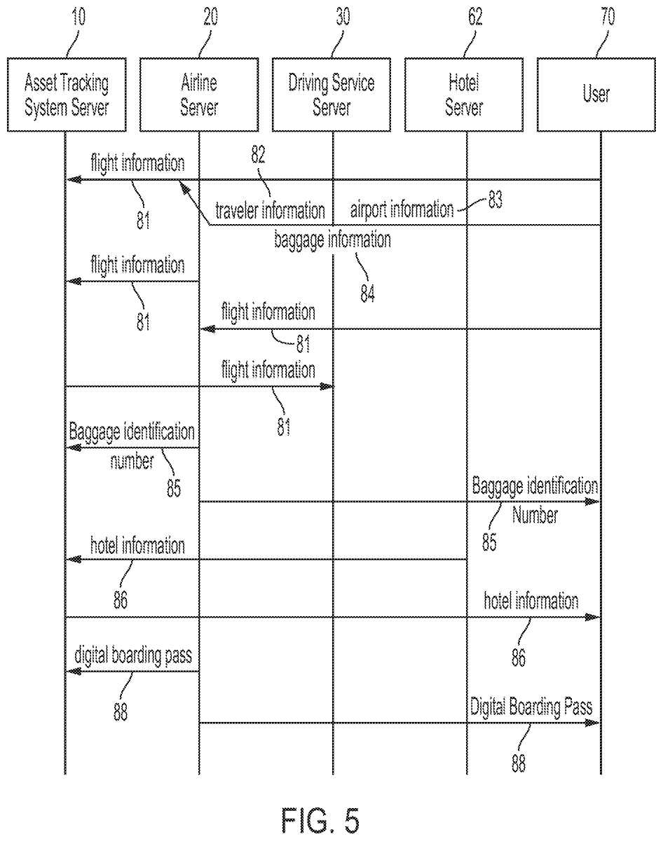

Referring now to FIG. 5, in operation, the user 70 may provide flight information 81 to the airline server 20 and/or the asset tracking system server 10. The flight information preferably includes traveler information 82, airport information 83, and baggage information 84. The airline server 20 is also preferably configured to provide flight information 81 to the asset tracking system server 10, either based upon input from the user 70 or based upon information already found within or generated by the airline server 20. The airline server 20 is also preferably configured to provide a baggage identification number 85 and a digital boarding pass 88 to the asset tracking system server 10 and/or to the user 70. The asset tracking system server 10 is also preferably configured to provide the flight information 81 to the driving service server 30. The hotel server 62 is preferably configured to provide hotel information 86 to the asset tracking system server 10, which is in turn preferably configured to provide the hotel information 86 to the user 70. The hotel information 86 preferably includes hotel room information and hotel room key information, but is not so limited and may also include information such as the address of the hotel 60 or other information about the hotel 60.

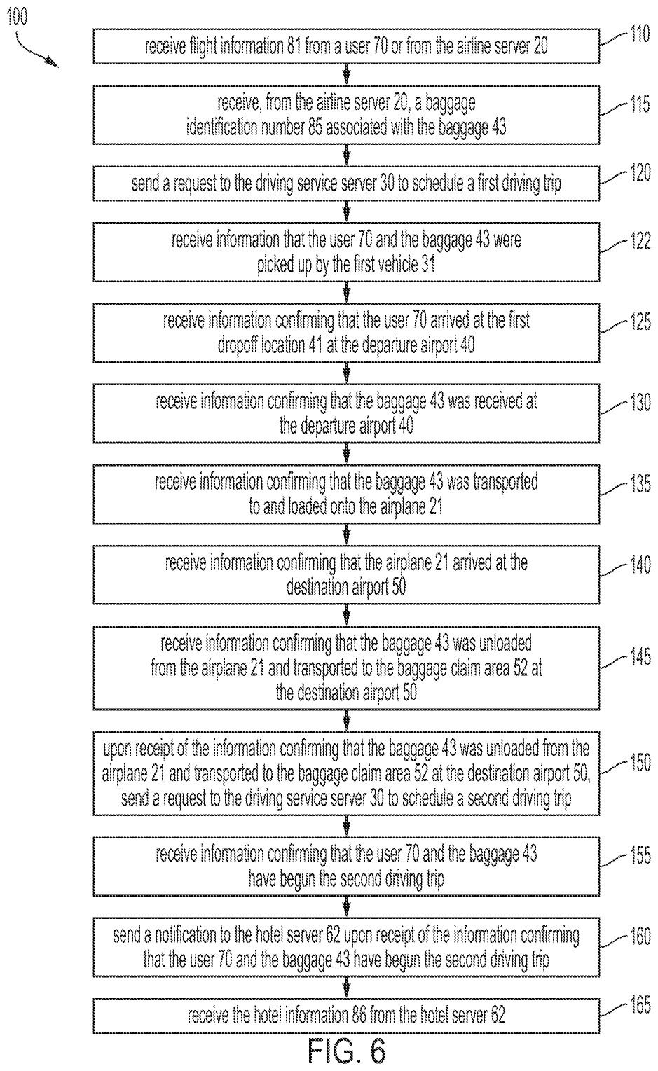

Referring now to FIG. 6, a first exemplary method 100 of using an embodiment of the present invention is shown. The first exemplary method includes the asset tracking system server 10 configured to perform a step 110 of receiving flight information 81 from a user of the system or from the airline server 20. Preferably, the flight information 81 includes traveler information, airport information, and baggage information. The asset tracking system server 10 is further preferably configured to perform a step 115 of receiving, from the airline server 20, a baggage identification number 85 associated with the baggage 43. The asset tracking system server 10 is also preferably configured to perform a step 120 of sending a request to the driving service server 30 to schedule a first driving trip. The request at step 120 preferably includes information regarding the baggage 43, the baggage identification number 85, the flight information 81, the departure airport 40, the first dropoff location 41, and the second dropoff location 42. The asset tracking system server 10 is also preferably configured to perform a step 122 of receiving information that the user 70 and the baggage 43 were picked up by the first vehicle 31. The asset tracking system server 10 is further preferably configured to perform a step 125 of receiving information confirming that the user 70 arrived at the first dropoff location 41 at the departure airport 40 or other designated dropoff location. The asset tracking system server 10 is also preferably configured to perform a step 130 of receiving information confirming that the baggage 43 was received at the departure airport 40, more preferably received at the second dropoff location 42. The asset tracking system server 10 is further preferably configured to perform a step 135 of receiving information confirming that the baggage 43 was transported to and loaded onto the airplane 21. The asset tracking system server 10 is further preferably configured to perform a step 140 of receiving information confirming that the airplane 21 arrived at the destination airport 50. The asset tracking system server 10 is also preferably configured to perform a step 145 of receiving information confirming that the baggage 43 was unloaded from the airplane 21 and transported to the baggage claim area 52 at the destination airport 50. The asset tracking system server 10 is further preferably configured to perform a step 150 of, upon receipt of the information confirming that the baggage 43 was unloaded from the airplane 21 and transported to the baggage claim area 52 at the destination airport 50, sending a request to the driving service server 30 to schedule a second driving trip. The asset tracking system server 10 is also preferably configured to perform a step 155 of receiving information confirming that the user 70 and the baggage 43 have begun the second driving trip. The asset tracking system server 10 is further preferably configured to perform a step 160 of sending a notification to the hotel server 62 upon receipt of the information confirming that the user 70 and the baggage 43 have begun the second driving trip. The asset tracking system server 10 is also preferably configured to perform a step 165 of receiving the hotel information 86 from the hotel server 62. The hotel information 86 preferably includes hotel room information and hotel room key information but is not so limited. For example, the hotel room information and hotel room key information may be used by the user 70 to access his or her hotel room 61 via a wireless communication protocol such as Near Field Communication.

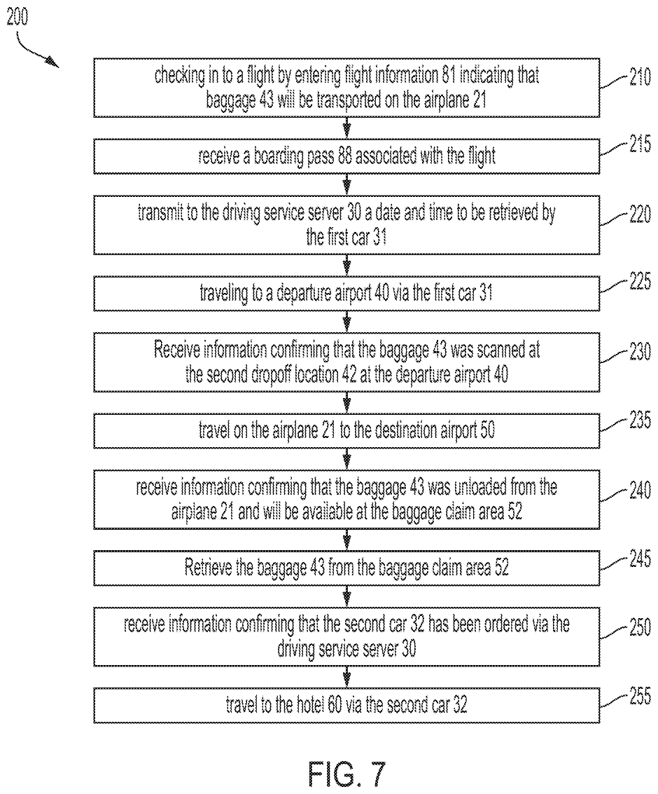

Referring now to FIG. 7, a second exemplary method 200 of using an embodiment of the invention is shown. The second exemplary method 200 preferably includes the user 70 who takes a first step 210 of checking in to a flight. Preferably, the first step 210 includes the tasks of entering flight information 81 indicating that baggage 43 will be transported on the airplane 21. The second exemplary method 200 also preferably includes a step 215 of receiving a boarding pass 88 associated with the flight. Preferably, the boarding pass 88 is digital and provided to the user's mobile phone 71, but the invention is not so limited and may be utilized with physical boarding passes such as those printed on paper or cardstock. The second exemplary method 200 further preferably includes the step 220 of transmitting to the driving service server 30 a date and time to be retrieved by the first car 31. The second exemplary method 200 also preferably includes the step 225 of traveling to a departure airport 40 via the first car 31. The second exemplary method 200 also preferably includes the step 230 of receiving information confirming that the baggage 43 was scanned at the second dropoff location 42 at the departure airport 40. The second exemplary method 200 further preferably includes the step 235 of traveling on the airplane 21 to the destination airport 50. The second exemplary method 200 also preferably includes the step 240 of receiving information confirming that the baggage 43 was unloaded from the airplane 21 and will be available at the baggage claim area 52. The second exemplary method 200 further preferably includes the step 245 of retrieving the baggage 43 from the baggage claim area 52. The second exemplary method 200 also preferably includes a step 250 of receiving information confirming that the second car 32 has been ordered via the driving service server 30. The second exemplary method 200 further preferably includes a step 255 of traveling to the hotel 60 via the second car 32.

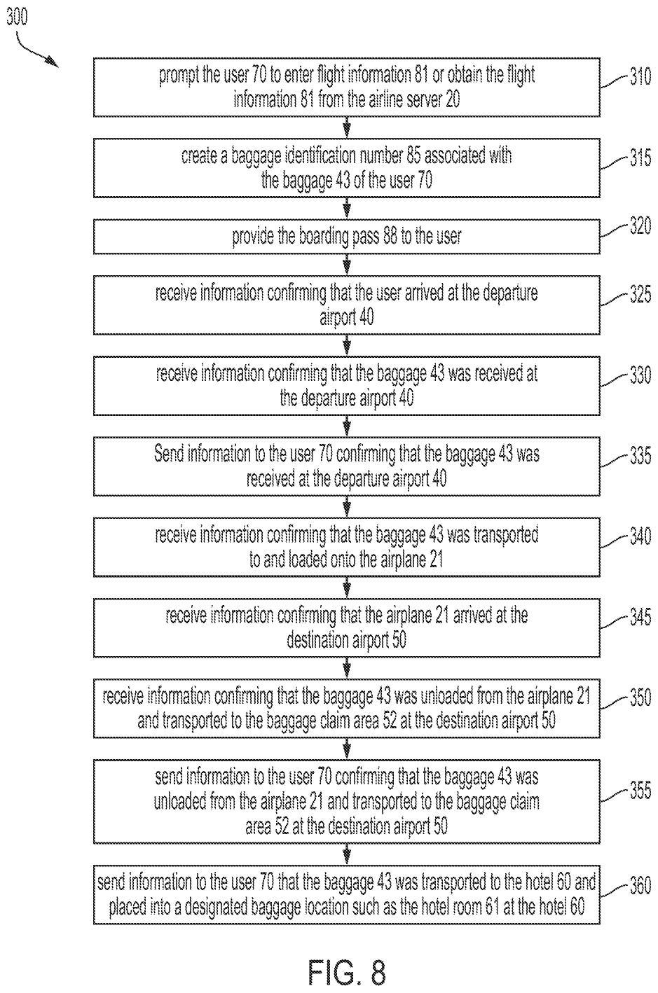

Referring now to FIG. 8, a third exemplary method 300 of using an embodiment of the invention is shown. The third exemplary method includes the airline server 20 configured to perform a step 310 of prompting the user 70 to enter flight information 81 or obtaining the flight information 81 from the airline server 20. The airline server 20 is further preferably configured to perform a step 315 of creating a baggage identification number 85 associated with the baggage 43 of the user 70. The airline server 20 is also preferably configured to perform a step 320 of providing the boarding pass 88 to the user. Preferably, the airline server 20 is configured to interface with the airline's Departure Control System (not shown) to associate the baggage identification number 85 with the baggage 43 of the user 70 and provide the boarding pass 88 to the user 70, but the invention is not so limited. The airline server 20 is further preferably configured to perform a step 325 of receiving information confirming that the user arrived at the departure airport 40. The airline server 20 is also preferably configured to perform a step 330 of receiving information confirming that the baggage 43 was received at the departure airport 40. The airline server 20 is further preferably configured to perform a step 335 of sending information to the user 70 confirming that the baggage 43 was received at the departure airport 40. The airline server 20 is also preferably configured to perform a step 340 of receiving information confirming that the baggage 43 was transported to and loaded onto the airplane 21. The airline server 20 is further preferably configured to perform a step 345 of receiving information confirming that the airplane 21 arrived at the destination airport 50. The airline server 20 is also preferably configured to perform a step 350 of receiving information confirming that the baggage 43 was unloaded from the airplane 21 and transported to the baggage claim area 52 at the destination airport 50. The airline server 20 is further preferably configured to perform a step 355 of sending information to the user 70 confirming that the baggage 43 was unloaded from the airplane 21 and transported to the baggage claim area 52 at the destination airport 50. The airline server 20 is also preferably configured to perform a step 360 of sending information to the user 70 that the baggage 43 was transported to the hotel 60 and placed into a designated baggage location such as the hotel room 61 at the hotel 60 or other designated dropoff location.

One skilled in the art will recognize that the present invention may be used with other asset identification tags such as those described in U.S. Pat. Nos. 6,994,262, 7,204,652, 7,845,569, and 7,909,955, and 8,052,061, the entire contents of which are herein incorporated in their entireties by reference.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the present disclosure.

I/We claim:

1. An asset tracking system comprising:
a central server configured to:
prompt a user to enter flight information, the flight information comprising flyer information, airport information, and baggage information;
create a baggage identification number associated with baggage of the user;
provide a boarding pass to the user;
receive information confirming that the baggage was received at the departure airport;
receive information confirming that the baggage was transported to and loaded onto an airplane;
receive information confirming that the airplane arrived at a destination airport; and
receive information confirming that the baggage was unloaded from the airplane and transported to a baggage claim area at the destination airport.

2. The system of claim 1, wherein the central server is further configured to receive information confirming that the user arrived at a departure airport.

3. The system of claim 1, wherein the central server is further configured to send information to the user confirming that the baggage was received at the departure airport.

4. The system of claim 1, wherein the central server is further configured to send information to the user confirming that the baggage was transported to and loaded onto the airplane.

5. The system of claim 1, wherein the central server is further configured to send information to the user confirming that the baggage was unloaded from the airplane and transported to the baggage claim area at the destination airport.

6. The system of claim 1, wherein the central server is further configured to send information to the user that the baggage was transported to a hotel and placed into a designated location at the hotel.

7. The system of claim 1, wherein the central server is further configured to send a request to a driving service server to schedule a first driving trip.

8. The system of claim 7, wherein the central server is further configured to send a first dropoff location and a second dropoff location to the driving service server, the first and second dropoff locations both located at a departure airport and determined at least in part based on the flight information.

9. An asset tracking system comprising:
a baggage dropoff scanner for accepting baggage;
a first conveyor system for transporting the baggage through a first airport to an airplane, the conveyor system having at least one scanner for tracking the location of the baggage; and
a loading scanner for tracking the baggage on to the airplane.

10. The asset tracking system of claim 9, further comprising a central server configured to send information to a user confirming that the baggage was transported to and loaded onto the airplane.

11. The asset tracking system of claim 10, wherein the central server is further configured to send information to the user confirming that the baggage was received at the departure airport.

12. The asset tracking system of claim 9, further comprising:
an unloading scanner for identifying the baggage as it is unloaded from the airplane;
a second conveyor system for transporting the baggage from the airplane through a second airport to a baggage claim area, the conveyor system having at least one scanner for tracking the location of the baggage; and
a baggage claim scanner for identifying the baggage as it is delivered to the baggage claim area.

13. The asset tracking system of claim 12, further comprising a central server configured to send information to a user confirming that the baggage was unloaded from the airplane.

14. The asset tracking system of claim 13, wherein the central server is further configured to send information to the user that the baggage was transported to the baggage claim area.

15. The asset tracking system of claim 14, wherein the central server is further configured to send information to the user that the baggage was placed into a car.

16. The asset tracking system of claim 13, wherein the central server is further configured to send information to a driving service server indicating that the baggage was unloaded from the airplane.
